(19) United States
(12) Patent Application Publication
(10) Pub. No.: US 2018/0334587 A1
(43) Pub. Date: Nov. 22, 2018

(54) DUAL-CURE EPOXY-SILOXANE COATING COMPOSITIONS

(71) Applicant: PPG Industries Ohio, Inc., Cleveland, OH (US)

(72) Inventors: Dikran Betzig, Bolton, MA (US); Qiang Huang, West Roxbury, MA (US)

(21) Appl. No.: 15/599,813

(22) Filed: May 19, 2017

(51) Int. Cl. C09D 163/04; C09D 163/00; C09D 7/12

(52) U.S. Cl. CPC C09D 163/04; C09D 7/1216; C09D 163/00

(57) ABSTRACT

Dual-cure coating compositions including an epoxy-functional component and a siloxane-functional component are disclosed. The epoxy-functional component includes an epoxy resin and a corrosion inhibitor, the siloxane-functional component includes a polysiloxane resin and a reactive organosilane, and either or both of the epoxy-functional component and the siloxane-functional component further comprises a thermoset co-binder resin having inorganic functionality in the polymer backbone. The coating composition undergoes a first curing reaction under ambient conditions, and a second curing reaction at temperatures of at least 100° C. Substrates at least partially coated with a coating deposited from such coating compositions, and methods for coating substrates with such coating compositions are also provided.

### FIELD OF THE INVENTION

The present invention pertains generally to epoxy-siloxane resin compositions that demonstrate excellent thermal performance, and more particularly to room-temperature cure epoxy-siloxane coating compositions comprising a thermoset co-binder resin.

### BACKGROUND OF THE INVENTION

The cost of corrosion in the U.S. piping industry is more than $8 billion annually. Oil and gas well pipes normally consist of relatively low cost, low carbon steel susceptible to hydrogen embrittlement, hydrogen sulfide induced corrosion, and chloride stress corrosion and cracking. To eliminate this problem, expensive corrosion-resistant stainless steel pipes and pipe linings are frequently used. Alternatively, approximately 10% of all new U.S. steel pipes are treated to resist corrosion.

In recent years, great technological advances have been seen in the field of anticorrosive paints. Epoxy based protective coatings represent one of the most widely used paints for corrosion control, providing long term protection of steel, concrete, aluminum, and other structures under a broad range of corrosive conditions, extending from atmospheric exposure to full immersion in strongly corrosive solutions. The use of siloxane resins as a desired resin additive in forming hybrid epoxy-siloxane protective coatings is also practiced. The siloxane bond is generally stable to heat and ultraviolet light. Use of epoxy resins with silicone resins to form hybrid epoxy-siloxane protective coatings offers the benefits of both silicone resin and epoxy resin; stability on exposure to light and heat from the siloxane resin and high adhesive strength from the epoxy resin. Improved epoxy-silane coatings are therefore desired.

### SUMMARY

The present invention is directed to a dual-cure epoxy-siloxane coating composition comprising an epoxy-functional component comprising (i) an epoxy resin and (ii) a corrosion inhibitor, and a siloxane-functional component comprising (i) a polysiloxane resin and (ii) a reactive organosilane hardener, wherein either or both of the epoxy-functional component and the siloxane-functional component further comprise (iii) a thermoset co-binder resin comprising an inorganic polymer backbone.

The present invention is also directed to substrates at least partially coated with a coating deposited from such coating compositions, and methods for coating substrates with such coating compositions.

### DETAILED DESCRIPTION

Throughout this description and in the appended claims, use of the singular includes the plural and plural encompasses singular, unless specifically stated otherwise. For example, although reference is made herein to “an” epoxy-functional component, “a” siloxane-functional component, “an” epoxy resin, “a” co-binder resin, “a” corrosion inhibitor, “a” polysiloxane resin, and “an” organosilane, one or more of any of these components and/or any other components described herein can be used.

As used herein, the term “multi-component” refers to coating compositions that include more than one component, such as those that include two components (“2K systems”), wherein the components are stored separately and then mixed at or near the time of use. While described herein as comprising an epoxy-functional component and a siloxane-functional component, it will be understood that any number of additional components can also be used in the formulation of the coating composition, wherein the components are admixed prior to or during application. The present coating compositions can therefore be multi-component, such as 2K systems. When reference is made herein to the “blended coating composition” it refers to the composition resulting when all of the components are mixed, such as just prior to application.

The word “comprising” and forms of the word “comprising”, as used in this description and in the claims, does not limit the present invention to exclude any variants or additions. Additionally, although the present invention has been described in terms of “comprising”, coating compositions detailed herein may also be described as consisting essentially of or consisting of. For example, while the invention has been described in terms of a coating composition comprising an epoxy-functional component and a siloxane-functional component, a coating composition consisting essentially of or consisting of an epoxy-functional component and a siloxane-functional component is also within the present scope. In this context, “consisting essentially of” means that any additional coating components will not materially affect the corrosion resistance, permeability, and/or glass transition temperature of the coating composition or coating deposited therefrom.

Furthermore, the use of “or” means “and/or” unless specifically stated otherwise. As used herein, the term “polymer” refers to prepolymers, oligomers and both homopolymers and copolymers, and the prefix “poly” refers to two or more. “Including” and like terms means including, but not limited to. When ranges are given, any endpoints of those ranges and/or numbers within those ranges can be combined within the scope of the present invention.

Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and appended claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

The present invention is directed to dual-cure epoxy-siloxane protective coating compositions. The dual-cure epoxy-siloxane coating composition may be provided in the form of a two-component system, e.g., wherein the ingredients are provided in two separate containers that are combined and mixed together prior to application. For example, the coating compositions of the present invention can be a two-component system or a multi component system, wherein a first component comprises an epoxy-functional component and a second component comprises a siloxane-functional component.

In the coating composition of the present invention, the dual-cure epoxy-siloxane coating composition includes an epoxy-functional component and a siloxane-functional component. The epoxy-functional component comprises (i) an epoxy resin and (ii) a corrosion inhibitor, and the siloxane-functional component comprises (i) a polysiloxane resin and (ii) a reactive organosilane. Either or both of the epoxy-functional component and the siloxane-functional component further comprise iii) a thermoset co-binder resin comprising an inorganic polymer backbone.

As used herein, the term “dual-cure” coating composition refers to a composition that will cure upon exposure to two different cure conditions. For example, the dual cure compositions of the present invention may have a first cure under ambient conditions. As used herein, the term “ambient conditions” means that the coating composition undergoes a crosslinking reaction without the aid of externally applied heat or other energy, for example, without baking in an oven, use of forced air, or the like. Ambient conditions may include temperatures across a broad range such as, for example, reduced temperatures (i.e., >0° C. to <25° C.) or slightly elevated temperatures (i.e., >25° C. to <100° C.). The dual cure compositions of the present invention may have a second cure upon exposure to thermal energy. As used herein, the term “thermal energy” is intended to include radiant energy such as infrared or microwave energy and the like; or conductive thermal energy such as that produced by a heated platen, hot air oven, or heated substrate material, for example.

Thus, the dual-cure coating compositions prepared according to the invention include a film forming resin which cures under ambient conditions to form a hardened film, and a thermoset co-binder resin which cures when the coating is heated to temperatures of at least 100° C., such as 150° C., or even 200° C. or higher. As used herein, the term “film-forming resin” refers to a resin that can form a self-supporting continuous film on at least a horizontal surface of a substrate upon removal of any diluents or carriers present in the composition or upon curing at ambient conditions or elevated temperature.

The epoxy-functional component comprises an epoxy resin that comprises a curable epoxide. As used herein, the term “curable” refers to the capability of a compound to undergo one or more chemical reactions to form stable, covalent bonds among the constituent components. The epoxy resins generally comprise more than one epoxy group per mole, and may be saturated or unsaturated, aliphatic, cycloaliphatic, or heterocyclic. The epoxy resins generally contain glycidyl ester or glycidyl ether groups, have a weight per epoxide (i.e., an epoxide equivalent weight) of from 100 to 10,000, such as 100 to 2,000, or 100 to 500, or even 100 to 300, and have a reactivity of at least two, such as 3 or greater. Suitable curable polyepoxides that may be used in the coating compositions of the present invention include epoxy polyethers, polyglycidyl ethers of one or more polyhydric alcohols, polyglycidyl esters of one or more polycarboxylic acids, epoxidated olefinically unsaturated alicyclic compounds, polyepoxides containing oxyalkylene groups, epoxy novolac resins, cardanol novolac resins, cardanol epoxy resins, or combinations thereof.

According to the present invention, the epoxy may comprise a curable polyepoxide such as a polyglycidyl ether of bisphenol A, a polyglygidyl ether of bisphenol F, a glycidyl ether of bisphenol, an epoxy phenol novolac, an epoxy cresol novolac, or combinations thereof. The curable polyepoxides may be prepared by the reaction of epichlorohydrin with a polyhydric organic compound, which can be a polyhydroxy phenol, such as bisphenol A, bisphenol F, trihydroxy diphenol dimethyl methane, 4,4′-dihydroxy biphenyl, and the like. Other polyhydric organic compounds are also useful, such as ethylene glycol, 2,3-butane diol, erythritol, glycerol, and the like.

Suitable epoxy resins include: Resolution Products in their EPON line of products (e.g., Epon 828, bisphenol A-epichlorohydrin epoxy resin and/or blends of this resin with difunctional epoxide reactive diluents such as neopentylglycol diglycidylether, resorcinol diglycidylether and cyclohexanedimethanoldiglycidylether; Epon DPL 862, bisphenol F-epiclorohydrin epoxy resin); CVC Thermoset Specialties in their EPALLOY line of products (e.g., Epalloy 8250, epoxy novalac resin); Araldite EPN 1139 from Ciba Geigy; and DEN432, DEN438, DEN439, and DEN440 from Dow Chemical. Suitable nonaromatic epoxy resins include hydrogenated cyclohexane dimethanol and diglycidyl ethers of hydrogenated Bisphenol A-type epoxide resin, such as: Resolution Products in their EPON line of products (e.g., Epon 1510, Epon 4080E, Heloxy 107 and Epon 1513, hydrogenated bisphenol A-epichlorohydrin epoxy resin); Santolink LSE-120 from Monsanto; Epodil 757 (cyclohexane dimethanol diglycidylether) from Pacific Anchor; Araldite XUGY358 and PY327 from Ciba Geigy; Epirez 505 from Rhone-Poulene; Aroflint 393 and 607 from Reichold; and ERL4221 from Union Carbide.

The epoxy-functional component further comprises a corrosion inhibitor. Examples of suitable corrosion inhibitors include, but are not limited to, sulphonates, phosphines, oxides and silicates; zinc oxide, zinc phosphate, zinc borate, zinc molybdate, barium metaborate, calcium borosilicate, barium sulfate, aluminum phosphate, magnesium oxide, strontium zinc phosphosilicate. Examples of phosphate based corrosion inhibitors include, for example, micronized HALOX SZP-391, HALOX 430 calcium phosphate, HALOX ZP zinc phosphate, HALOX SW-111 strontium phosphosilicate, HALOX 720 mixed metal phosphor-carbonate, and HALOX 700, 550 and 650 proprietary organic corrosion inhibitors commercially available from Halox, Hammond, Ind. Other suitable corrosion inhibitors may include HEUCOPHOS ZPA and ZAPP zinc aluminum phosphate, HEUCOPHOS ZAM and ZMP zinc molybdenum phosphates, HEUCOPHOS ZPO zinc orthophosphates, HEUCOPHOS SAPP and SRPP strontium aluminum polyphosphate hydrates, and HEUCOPHOS CAPP calcium aluminum polyphosphates, commercially available from Heucotech Ltd, Fairless Hills, Pa.; RAYBO 60, 85; NUBIROX 301, 302 calcium strontium phosphosilicate; NACORR 1151, 1551, and XR-424.

The siloxane-functional component comprises a polysiloxane resin, such as an organosiloxane. A general chemical structure of an organosiloxane is shown in the formula below,

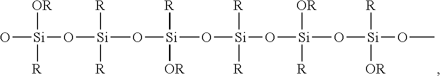

wherein the R group is independently hydrogen, methyl, ethyl, propyl, octyl, pentyl, acrylic or other organic substituents.

The polysiloxane resins of the present invention may be aminofunctional silicone resins comprising the units (i): (R₃SiO_{1/2})ₐ; (ii): (R₂SiO_{2/2})_{b}; (iii): (RSiO_{3/2})_{c} and (iv): (SiO_{4/2})_{d}, wherein “R” is independently an alkyl, aryl group, or an amino-functional hydrocarbon group; and wherein “a” has a value of less than 0.4, “b” has a value of zero or greater than zero, “c” has a value of greater than zero to 0.7, “d” has a value of less than 0.3, and the value of a+b+c+d=1, with the provisos that 3 to 50 mole percent of silicon atoms contain amino-functional hydrocarbon groups in units (i), (ii) or (iii), the NH equivalent weight of the amino-functional silicone resin is from 100 to 1500, alternatively from 100 to 1000, alternatively from 150 to 350, the amino-functional silicone resin is in the form of a neat liquid, solution, or meltable solid, greater than 20 weight percent of unit (ii) is present in the amino-functional silicone resin, less than 10 weight percent of unit (ii) are Me₂SiO_{2/2} units in the amino-functional silicone resin, and greater than 50 weight percent of silicon-bonded R groups are silicon-bonded aryl groups, and at least 30 weight percent of all silicon atoms contain an aryl group. The NH equivalent weight, as used herein, means the weight of material that contains one atomic weight of amine hydrogen. An exemplary amino-functional silicone resin may comprise a composition of 50-70 weight percent phenyl R₂SiO and 20-30 weight percent of dimethyl R₂SiO, based on the total weight of the silicone resin.

The polysiloxane resins of the present invention may be silanol-functional silicone resins comprising the units (R₃SiO_{1/2})ₐ; (R₂SiO_{2/2})_{b}; (RSiO_{3/2})_{c} and (SiO_{4/2})_{d}, wherein “R” is independently an alkyl, aryl group, or an silanol-functional hydrocarbon group; and wherein the value of a+b+c+d=1. An exemplary silanol-functional silicone resin may be a phenyl-methyl silicone resin having a phenyl to methyl ratio ranging from 2:1 to 1:1, and may comprise a silicon dioxide (SiO) content of 50-65 weight percent, based on the total weight of the silicone resin.

The polysiloxane resins of the present invention may have the formula:

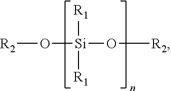

wherein each R₁ may be selected from the group consisting of the hydroxy group and alkyl, aryl, and alkoxy groups having up to six carbon atoms. Each R₂ may independently comprise hydrogen and alkyl and aryl groups having up to six carbon atoms. In the above formula, n may be an integer selected so that the molecular weight of the polysiloxane is in the range of 400 to 10,000 Daltons. The R₁ and R₂ may comprise groups having less than six carbon atoms, for example, to facilitate rapid hydrolysis of the polysiloxane, which reaction may be driven by the volatility of the alcohol analog product of the hydrolysis. According to certain aspects, R₁ and R₂ groups having greater than six carbon atoms may impair the hydrolysis of the polysiloxane due to the relatively low volatility of each alcohol analog. According to certain aspects, methoxy, ethoxy and silanol functional polysiloxanes having n selected such that the molecular weights are 400 to 2000 may be used for formulating coating compositions of the present invention.

The siloxane-functional component further comprises a reactive organosilane hardener. Exemplary reactive organosilanes include trialkoxy-functional silanes represented by the general formula X—R—Si(OR′)₃, where X is a nonhydrolyzable organic radical selected from amino, vinyl, aryl, alkyl, dialkylaryl, alkoxyalkyl, alkylaminoalkyl, or cycloalkyl radicals, R is an aryl, alkyl, hydroxyalkyl, alkoxyalkyl, or hydroxyalkoxyalkyl having less than six carbon atoms, and each R′ is independently selected from alkyl, hydroxyalkyl, alkoxyalkyl, or hydroxyalkoxyalkyl groups each containing less than six carbon atoms.

The reactive organosilane hardeners may also include trialkoxy-functional aminosilanes represented by the general formula:

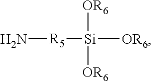

where R₅ is a difunctional organic radical selected from amino, aryl, alkyl, dialkylaryl, alkoxyalkyl, alkylaminoalkyl, or cycloalkyl radicals, and each R₆ is independently selected from alkyl, hydroxyalkyl, alkoxyalkyl, or hydroxyalkoxyalkyl groups each containing less than six carbon atoms.

Suitable trialkoxy functional aminosilanes may include amino-propyl trimethoxysilane, amino-propyl triethoxysilane, amino-propyl tripropoxysilane, amino-neohexyl trimethoxysilane, N-β-(aminoethyl)-γ-amino-propyl trimethoxysilane, N-β-(aminoethyl)-γ-amino-propyl triethoxysilane, N-phenylaminopropyl trimethoxysilane, trimethoxysilylpropyl-diethylene-triamine, 3-(3-aminophenoxy)propyl trimethoxysilane, aminoethyl-aminomethyl-phenyl trimethoxysilane, 2-aminoethyl-3-aminopropyl-tris-2-ethylhexoxysilane, N-aminohexyl-aminopropyl trimethoxysilane, and trisaminopropyl trismethoxy-ethoxysilane. Examples of suitable commercially available trialkoxy functional silanes include at least Momentive silanes from the SILQUEST line and Dow coming silanes from the XIAMETER line.

The dual-cure epoxy-siloxane coating composition further comprises a thermoset co-binder resin comprising an inorganic polymer backbone. The thermoset co-binder resin can be included in either or both of the epoxy-functional component and the siloxane-functional component.

The thermoset co-binder resin may comprise a polymer backbone having silicone functionality. Suitable co-binder resins include siloxanes, polysiloxanes, polysilazanes, polyesters-siloxanes, polyamide-siloxanes, or any combination thereof.

The thermoset co-binder resin may comprise silicones such as polydialkylsiloxanes (i.e., polydimethylsiloxane, phenylmethylpolysiloxane). The polydialkylsiloxanes typically have a weight average molecular weight of 1,000 to 500,000, such as in the range of 1,500 to 15,000, or 2,000 to 5,000, or in the range of 100,000 to 500,000, measured by GPC using polystyrene calibration standards. The lower molecular weight polydialkylsiloxanes may cure or harden at temperatures as low as 100° C., such as 150° C., while the high molecular weight polydialkylsiloxanes may cure at temperatures as low as 200° C.

The thermoset co-binder resin may comprise polydimethylsiloxane (PDMS) containing copolymers. Incorporation of PDMS into a wide variety of homopolymers to form block or segmented copolymers is made possible due to the many organo-reactive endgroups that can be placed onto the siloxane segment. These can include carboxyl, hydroxyl, amino, epoxy, as well as others. Although possessing a very low glass transition temperature, polyorganosiloxanes are able to maintain thermal stability over a wide temperature range in both inert and oxidizing environments.

Accordingly, the thermoset co-binder resin may comprise polyester-siloxane resins, wherein the polyester component may be prepared in a known manner by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Typical polyester siloxanes cure at temperatures above 200° C., such as, for example, 220° C.

The thermoset co-binder resin may comprise polyamide-siloxane resins, wherein suitable polyamides include imidazoline group-containing polyaminoamides based on mono or polybasic acids, as well as adducts thereof.

The thermoset co-binder resin may comprise a polysilazane. Polysilazanes are polymers which contain repeat units wherein silicon and nitrogen atoms are bonded in alternating sequence. Polysilazanes all possess reactive Si—N functionality which enables co-reaction with various electrophilic organic materials, such as epoxy resins. For the practice of this invention, it will be understood that the term “polysilazane” as appearing in the specification and claims is intended as a generic expression, and includes compounds comprising a multiplicity of sequential Si—N bonds, and includes oligomers and polymers, and is not restricted to pure polysilazanes alone, but to such derivatives as polyureasilazanes, poly(thio)ureasilazanes, polyborosilazanes, and polysiloxazanes. Also included are the reaction products of the above-mentioned polymers with other inorganic or organic moieties which result in hybrid polymer compositions still comprising a multiplicity of sequential Si—N bonds.

While the thermoset resins have been described as requiring thermal energy to initiate curing or hardening, certain accelerators may be added which may increase the cure speed and/or reduce the cure temperature. For example, melamine may be added to compositions comprising a polyester siloxane to reduce the cure temperature and/or increase the cure speed.

The coating compositions of the present invention may comprise from 3 to 30 weight percent of the epoxy resin, such as 5 to 15 weight percent of the epoxy resin, from 5 to 30 weight percent of the corrosion inhibitor, such as 6 to 25 weight percent of the corrosion inhibitor, from 3 to 30 weight percent of the polysiloxane resin, such as 5 to 15 weight percent of the polysiloxane resin, from 0.5 to 20 weight percent of the reactive organosilane hardeners, and from 1 to 40 weight percent of the thermoset co-binder resin, based on the total weight of the coating composition.

The amount of thermoset co-binder resin added may depend on at least the weight average molecular weight of the resin, and the total solids content of the resin as supplied. For example, the low weight average molecular weight resins are generally supplied at very high solids content and may be added at from 1 to 10 weight percent, while certain of the high weight average molecular weight resins, which are supplied at lower solids content, may be added at from 20 to 40 weight percent, based on the total weight of the coating composition. Low and high weight average molecular weight may be as defined above, wherein low weight average molecular weight may be from 1,500 to 15,000, and high weight average molecular weight may be from 100,000 to 500,000.

As noted above, the thermoset co-binder resin can be included in the epoxy-functional component, and/or it could also be included in the siloxane-functional component. The thermoset co-binder resin may be cold blended with either component, wherein “cold blend” indicates that the thermoset co-binder resin is mixed with the other ingredients at temperatures that will not initiate a curing or hardening reaction for the thermoset co-binder resin, such as ambient conditions.

The siloxane-functional component, when combined with the epoxy-functional component, results in an ambient cured coating; this coating may have improved flexibility, improved weatherability and/or improved corrosion resistance as compared with other epoxy coatings. Typically, the siloxane reacts with the epoxy resin by an acid or base catalyzed hydrolysis of the siloxane resin and a reactive organosilane hardener, followed by condensation of the resulting silanol groups formed during hydrolysis and reaction of amine (e.g., from either or both of the siloxane resin or the reactive organosilane hardener) with epoxy. This reaction mechanism is initiated by the presence of moisture, conducted in the presence of an amine, and driven to completion by evaporation of alcohol formed during the hydrolysis reaction.

As such, the present coating composition may comprise water and the water may be present in an amount sufficient to bring about both the hydrolysis of the polysiloxane and the subsequent condensation of the silanols. Non-limiting sources of water may include atmospheric humidity and adsorbed moisture on the barrier pigment and/or filler material. Additional water may be added, for example, to accelerate cure depending on ambient conditions, such as the use of the coating composition in arid environments. If desired, water may be added, such as to the epoxy-functional component. Other sources of water may include trace amounts present in the epoxide resin, cure system, thinning solvent, or other ingredients.

The present coating composition may comprise a cure accelerator. The cure accelerator may be a metal catalyst in the form of an organometallic catalyst comprising one or more metals. Cure accelerators comprising at least one organometallic catalyst may be useful for the purpose of further accelerating the curing rate of the coating composition into a protective film coating over a broad temperature range. In certain uses requiring curing at lower temperatures, the organometallic catalyst cure accelerator may provide accelerated cure rates.

Suitable cure accelerators may include at least one metal catalyst comprising a metal selected from zinc, manganese, zirconium, titanium, cobalt, iron, lead, bismuth, or tin and having the formula:

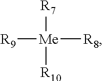

wherein
“Me” is the metal, R₇ and R₈ may be independently selected from acyl groups, alkyl groups, aryl groups, or alkoxy groups, wherein the acyl, alkyl, aryl and alkoxy groups may each have up to twelve carbon atoms. R₉ and R₁₀ may be selected from those groups set forth for R₇ and R₅ or from inorganic atoms such as halogens, sulfur or oxygen. In specific embodiments the R₇, R₅, R₉ and R₁₀ groups may be selected from butyl, acetates, laurates, octanoates, neodecanoates or naphthanates. In specific embodiments, the cure accelerator may be an organometallic tin catalyst or titanium catalyst, such as, for example, dibutyl tin dilaurate, dibutyl tin diacetate, dibutyl tin diacetyldiacetonate, dioctyltindilaurate, dioctyltindiacetate, or organotitanates. In certain embodiments, the coating composition may comprise up to about 5% by weight of the cure accelerator, based on the total weight of the coating composition.

The epoxy-siloxane polymer formed by components of the present invention may include skeletons of repetitive —Si—O-units, chemically bonded to lateral epoxy organic chains, as shown in the formula below:

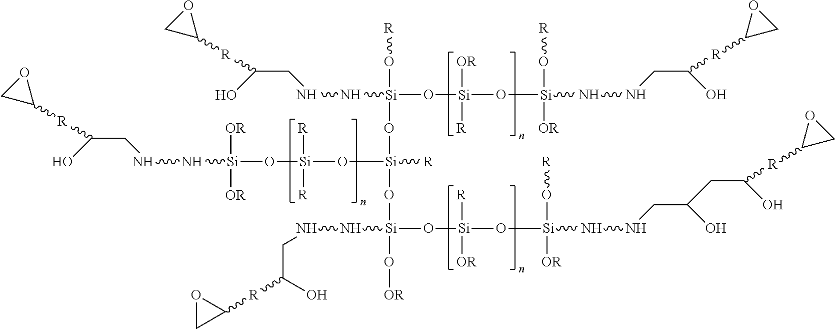

The epoxy-siloxane polymers formed by the components of the present invention cure under ambient conditions to form a hardened film. Bonding through the reactive organosilane is often more complex than a single bond. At the interface, the silane reacts with itself and also the polymer, crosslinking and interlocking mechanically with the polymer. Inter-diffusion phenomenon and semi-inter-penetrating network (IPN) phenomena occur in the interphase region and influence the overall composite performance. Factors that influence the formation of this network are the hydrolysis/condensation rate, solubility parameters, and structural characteristics of the two materials and their thermal stability. Thus, chemical structure matching may enhance the physical properties.

The thermoset co-binder resin is added to extend the thermal stability of the epoxy-siloxane coatings deposited from the coating compositions. Continuous exposure to moderate temperatures in standard or moisture laden environments is frequently worse than continuous exposure to high temperatures which would “dry” the substrate. For example, steel pipes which experience humid environments or condensation are more likely to corrode, even when coated with a protective coating, than those which remain dried in a high temperature environment. Thermal cycling can lead to the formation of cracks and/or pores in a coating which provide exposure to this moisture.

The thermoset co-binder resins of the present invention cure at temperatures of at least 100° C., such as at least 150° C., or even at least 200° C., and may extend the temperature range of the coating beyond standard epoxy-siloxane coatings. The inorganic backbone of the thermoset co-binder resin may provide additional thermal stability to the resin. For example, the inorganic backbone may include silicone functionality. Polysiloxanes are extremely flexible molecules due to the free rotation about the Si—O and Si—C bonds. Because of this, the siloxane bond —Si—O— has a binding energy of 445 kJ/mol, which is higher than the 358 kJ/mol of the —C—C— bond that forms the repetitive unit of organic polymers. Standard organic polymers may degrade or burn at higher temperatures. Thus, inclusion of co-binder resins comprising a silicone backbone provides increased thermal stability to the co-binder resin, and thus the dual-cure epoxy-siloxane coating compositions of the present invention.

The thermal energy required to provide curing for the thermoset co-binder resin is generally provided in situ. That is, coated metal substrates such as, for example, oil and gas pipes, which experience exposure to high temperatures and/or temperature fluctuations may be coated with the coating compositions of the present invention under ambient conditions. The epoxy resin and siloxane resin of the two component system react to provide a hardened film which is stable enough to allow the coated metal substrate to be handled, shipped, and/or installed. In use, exposure of the coated metal substrate to temperatures at or above 200° C. cause the thermoset co-binder resin to polymerize, further hardening the coating.

The coating compositions of the present invention may also comprise a barrier pigment. Either or both of the epoxy-functional component and the siloxane-functional component may comprise the barrier pigment. Suitable barrier pigments include micaceous iron oxide, glass flake, borosilicate glass flake (surface treated), leafing aluminum, aluminum, stainless steel, graphite, zinc, zinc flake, nano clays, perlite, kaolin flake, or mica and/or a filler pigment such as iron oxide, barites, talc, calcium carbonate or titanium dioxide. Barrier pigments may be included in the coating composition in amounts up to 60 weight percent, such as from 20 to 60 weight percent, based on the total weight of the coating composition.

The coating compositions of the present invention may also comprise any additives standard in the art of coating manufacture including moisture scavengers, light stabilizers, plasticizers, colorants, abrasion-resistant particles, film strengthening particles, flow control agents, thixotropic agents, rheology modifiers, catalysts, antioxidants, biocides, defoamers, surfactants, wetting agents, dispersing aids, adhesion promoters, stabilizing agents, fillers, barrier and/or filler pigments, organic cosolvents, reactive diluents, grind vehicles, and other customary auxiliaries, or combinations thereof. When used, these additives may comprise 0.1 to 35 weight percent, based on the total weight of the coating composition.

According to the present invention, either or both of the epoxy-functional component and the siloxane-functional component may comprise a light stabilizer. Exemplary light stabilizers include liquid hindered amine light stabilizers (“HALS”) or UV light stabilizers. Examples of suitable HALS include, for example, TINUVIN HALS compounds such as TINUVIN 292, TINUVIN 123, TINUVIN 622, TINUVIN 783, TINUVIN 770 commercially available from BASF, Ludwigshafen, Germany. Examples of suitable UV light stabilizers include, for example, CYASORB light stabilizers, such as CYASORB UV-1164L (2,4-bis (2,4-dimethylphenyl-6-(2-hydroxy-4-isooctyloxyphenyl-1,3,5-triazine), commercially available from Cytec Industries, Woodland Park, N.J. and TINUVIN 1130 and TINUVIN 328 commercially available from BASF, Ludwigshafen, Germany. When used, the light stabilizer may be included in the coating composition in amounts ranging from 0.25 to 4.0 weight percent, based on the total weight of the coating composition.

According to the present invention, either or both of the epoxy-functional component and the siloxane-functional component may comprise one or more plasticizers. Suitable plasticizers, for example, include phthalate esters, chlorinated paraffins, and hydrogenated terphenyls. Examples of useful plasticizers include HB-40 modified polyphenyl (Solutia, Inc.) and tung oil (Campbell & Co.). When used, the plasticizer may be included in the coating composition in amounts ranging from 1 to 40 weight percent, such as 1 to 8 weight percent, based on the total weight of the coating composition.

According to the present invention, either or both of the epoxy-functional component and the siloxane-functional component may comprise one or more colorants. As used herein, the term “colorant” means any substance that imparts color and/or other opacity and/or other visual effect to the composition. The colorant can be added to the coating composition in any suitable form, such as discrete particles, dispersions, solutions and/or flakes. A single colorant or a mixture of two or more colorants can be used in the coating compositions of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent- and/or aqueous-based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle.

Example special effect compositions that may be used in the coating composition of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present invention, either or both of the epoxy-functional component and the siloxane-functional component may further comprise one or more siliceous materials, such as, for example, silica, clay, such as bentone clay, talc, feldspar, and the like. The average particle size of the siliceous material varies depending on the material chosen, but typically ranges from 0.01 to 20 microns. One or more siliceous materials may be used, wherein one or more of these materials have been pre-reacted with a polyalkoxysilane or siloxane having at least one active hydrogen atom that is reactive with the epoxy group of the curable polyepoxide. When used, the siliceous material(s) may be present in an amount of 2 to 50 weight percent, based on the total weight of the coating composition.

The coating compositions of the present invention can be liquid, such as solvent-based coating compositions and electrodepositable coating compositions, or in the form of a co-reactable solid in particulate form, i.e., a powder. Solvent-based coatings include an organic solvent as the primary diluent (i.e. greater than 50 percent).

Accordingly, the epoxy-functional component and/or siloxane-functional component may also comprise a liquid vehicle, such as an organic solvent. Suitable organic solvents include aromatic petroleum distillates like toluene, xylene, tri-methyl benzene, and aromatic blends commercially available from Exxon Corporation like SOLVESSO 100 and SOLVESSO 150; aliphatic solvents like cyclohexane and naphthas; ketone solvents like acetone, butanol, dimethyl ketone, 2-propanol, methyl ethyl ketone, methyl isobutyl ketone, and methyl amyl ketone; alcohols like ethyl alcohol, propyl alcohol, and diacetone alcohol; mono- and dialkyl ethers of ethylene and diethylene glycol like ethylene glycol monoethyl ether, ethylene glycol monobutyl ether, ethylene glycol monoethyl ether acetate, diethylene glycol monobutyl ether, and diethylene glycol diethyl ether. The epoxy-functional component may also comprise an organic solvent such as butyl acetate, isopropyl alcohol, OXSOL 100, or dimethyl carbonate. In general, in order to meet EPA requirements, solvents having low vapor pressure (e.g., <0.1 mm) and/or high melting point (e.g. >20 C) and/or greater than 12 carbon atoms may be used in certain embodiments. When used, the solvent may be included in to coating composition in amount of from 5 to 30 weight percent, based on the total weight of the coating composition.

The solvent may be included in either or both he epoxy-functional component or the siloxane-functional component. In one embodiment, the solvent is included in the epoxy-functional component in amounts from 5 to 30 weight percent, based on the total weight of the coating composition.

Regardless of the form, liquid or solid, the coating compositions of the present invention may be pigmented or clear, and may be used alone or in combination with other coatings as primers, basecoats, or topcoats. The present invention may be directed to substrate primer coating compositions and/or metal substrate pretreatment coating compositions. As used herein, the term “primer coating composition” refers to coating compositions from which an undercoating may be deposited onto a substrate. In some industries or substrates, the primer is applied to prepare the surface for application of a protective or decorative coating system. In other industries or substrates, another coating layer is not applied on top of the primer. For example, substrate surfaces that have limited or no external exposure might have a primer with no other layer on top. As used herein, the term “pretreatment coating composition” refers to coating compositions that can be applied at very low film thickness to a bare substrate to improve corrosion resistance or to increase adhesion of subsequently applied coating layers.

Substrates that may be coated with coating compositions of the present invention include any substrates known in the art, for example, automotive substrates, marine substrates, industrial substrates, packaging substrates, metal, wood, glass, cloth, plastic, foam, including elastomeric substrates and the like. In many cases, the substrate comprises a metal substrate such as substrates comprising steel (including electrogalvanized steel, cold rolled steel, hot-dipped galvanized steel, among others), zinc, zirconium, titanium, aluminum, aluminum alloys, zinc-aluminum alloys, clad aluminum, and aluminum plated steel. Further, substrates that may be coated with coating compositions of the present invention may comprise more than one metal or metal alloy, in that the substrate may be a combination of two or more metal substrates assembled together, such as hot-dipped galvanized steel assembled with aluminum substrates. The substrate can be one that has been already treated in some manner, such as to impart visual and/or color effect, or some performance enhancement such as corrosion resistance. The substrate can be a vehicle. “Vehicle” is used herein in its broadest sense and includes all types of vehicles, such as but not limited to cars, trucks, buses, tractors, harvesters, heavy duty equipment, vans, golf carts, motorcycles, bicycles, railroad cars, airplanes, helicopters, boats of all sizes and the like. The substrate can also be a package. A “package” is anything used to contain another item, particularly for shipping from a point of manufacture to a consumer, and for subsequent storage by a consumer. A package will be therefore understood as something that is sealed so as to keep its contents free from deterioration until opened by a consumer, and is therefore distinguished from a storage container or bakeware in which a consumer might make and/or store food; such a container would only maintain the freshness or integrity of the food item for a relatively short period.

The dual-cure epoxy-siloxane coating composition may provide corrosion protection on substrates such a stainless and carbon steel substrates (e.g., low carbon steel). Possible substrates for the application of this coating include, for example, external pipes, tanks, off-shore oil drilling platforms, metallic framework, gas turbine, engines, heat exchangers, interior/exterior of hydrocarbon and chemical process equipment. In particular, the dual-cure epoxy-siloxane coating composition may be useful for high temperature cyclic coatings under insulation (CUI coatings). Because it imparts improved thermal and chemical resistance potential, opportunities outside of traditional protective coatings include, for example, fire resist and/or intumescent coatings.

Accordingly, the present invention is further directed to a substrate coated at least in part with the coating deposited from a coating composition according to the present invention. As used herein, the terms “on”, “applied on/over/to”, “formed on/over”, “deposited on/over”, “overlay” and “provided on/over” mean formed, overlay, deposited, or provided on but not necessarily in contact with the surface. For example, a coating layer “applied to” a substrate does not preclude the presence of one or more other coating layers of the same or different composition located between the applied coating layer and the substrate.

The coating compositions of the present invention, which may be, for example, metal substrate primer coating compositions and/or metal substrate pretreatment coating compositions, may be applied to bare metal. By “bare” is meant a virgin material that has not been treated with any pretreatment compositions, such as, for example, conventional phosphating baths, heavy metal rinses, etc. Additionally, bare metal substrates being coated with the coating compositions of the present invention may be a cut edge of a substrate that is otherwise treated and/or coated over the rest of its surface. Further, the substrate may be abraded prior to application of the coating and/or pretreatment. “Abraded” means to partially wear away the surface of the substrate by mechanical action. This can be by hand or machine, using abrasive materials such as sandpaper, SCOTCHBRITE pads, or slurries of abrasive materials such as rubbing compounds or polishing compounds.

Before applying a coating composition of the present invention as a primer and/or a metal pretreatment, the metal substrate to be coated may first be cleaned to remove grease, dirt, or other extraneous matter. Conventional cleaning procedures and materials may be employed. These materials could include, for example, mild or strong alkaline cleaners, such as those that are commercially available. Examples include BASE Phase Non-Phos and BASE Phase #6, both of which are available from PPG Industries, Pretreatment and Specialty Products. Other examples include ALK-660 and ED-500, both of which are available from PPG Industries, Aerospace Coatings Products. The application of such cleaners may be followed and/or preceded by a water rinse.

The metal surface may then be rinsed with an aqueous acidic solution after cleaning with the alkaline cleaner and before contact with the present coating compositions. Examples of suitable rinse solutions include mild or strong acidic cleaners, such as the dilute nitric acid solutions commercially available. Examples include AC-5, AC-12, and EAC-8, all of which are available from PPG Industries, Aerospace Coatings Products. Combination cleaning/abrading solutions can also be used.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used. The coating compositions of the present invention may be applied to a substrate by spraying via a nozzle assembly using an external spraying apparatus. In such an apparatus, the components of the coating composition are drawn in separate streams from their respective packages or containers whereby the streams intermingle and mix prior to contacting the substrates and the coating composition cures immediately on the substrate.

Typically, intermingling and mixing of the streams occurs after they leave the external spraying device but before being applied to the substrate using a multi-nozzle spraying apparatus. For example, two adjacent atomizing nozzles can be positioned so that separate streams are atomized and expelled from the spraying apparatus as separate atomized streams. Atomization occurs by applying pressurized air to the nozzles. The nozzles are positioned so that the separate atomized streams overlap prior to reaching the substrate. A typical spraying apparatus is as described in U.S. Pat. No. 5,713,519.

The application and curing of the coating compositions of the present invention may occur at ambient conditions, typically 15-30° C., but can occur at ambient conditions comprising reduced temperatures (i.e., >0° C. to <25° C.) or elevated temperatures (i.e., >25° C. to <100° C.).

According to the present invention, after application of the coating composition to the substrate, a film is formed on the surface of the substrate as the dual cure process proceeds. Suitable cure conditions will depend on the particular composition and/or application, but in some instances a curing time of from 30 minutes to 24 hours at a temperature greater than 0° C. will be sufficient, as measured by dry to touch.

More than one coating layer of the present composition may be applied if desired. According to the present invention, two or more coating layers are applied “wet-on-wet”, wherein at least one of the coatings comprises the coating of the present invention. Usually between coats, the previously applied coat is flashed; that is, exposed to ambient conditions for the desired amount of time.

According to the present invention, the wet film thickness of the coating composition may be from 25 to 2000 microns, such as 50 to 500 microns, and the dry film thickness of the cured coating may be from 20 to 1500 microns, such as from 40 to 300 microns. Coating thickness may vary depending on number and type of additives.

### Examples

The following examples describe the preparation of various coating compositions according to the present invention. Certain of these exemplary compositions are formulated and tested for mass loss (loss on ignition, LOI) performance, impact and corrosion resistance, adhesion, flexibility, and hardness, and these results are contrasted with results from similar testing of comparative coating compositions.

Preparation of Coating Compositions

Two-component coating compositions were prepared from an epoxy-functional component and a siloxane-functional component as follows. The epoxy-functional component was prepared by mixing, in a suitable vessel, an epoxy resin, which is a curable polyepoxide, with the thermoset co-binder resin and corrosion inhibitor, in the presence of a solvent. The siloxane-functional component was prepared by mixing the polysiloxane resin, reactive organosilane, and a solvent in a suitable vessel.

Shown in Table I are formulations A-E, which represent various ratios of the epoxy resin and the thermoset co-binder resin. Comparative example A was formulated without the thermoset co-binder resin and reactive organosilane. Certain of these formulations were tested for mass loss (LOI), as shown in Table IV, and corrosion resistance, as shown in Table V.

Table II details formulations 1-18, which represent exemplary mixtures of an epoxy resin, a siloxane resin, and a thermoset co-binder resin according to the present invention, and formulations C1 and C2, which are comparative examples that omit the thermoset co-binder resin. All formulations in Table II include 1.5 weight percent of a reactive organosilane (aminopropyltriethoxysilane); 5 to 25 weight percent of micaceous iron oxide; and 5 to 15 weight percent of glass flake; and the remainder includes fillers, solvents, and rheology modifiers. While these formulations include two barrier pigments, inclusion of a single barrier pigment (e.g., either micaceous iron oxide or glass flake) was found to provide similar results.

Certain of the formulations listed in Table II were tested for impact and corrosion resistance, adhesion, flexibility, and hardness, as shown in Table IV. Specific formulation details for those samples are listed in Table II, wherein all formulations include 1.5 weight percent of a reactive organosilane (aminopropyltriethoxysilane), and the remainder includes fillers, solvents, and rheology modifiers.

TABLE I

| | | WEIGHT PERCENT | | | | |
|---|---|---|---|---|---|---|
| RAW | Formulation | Formulation | Formulation | Formulation | Formulation | Comparative |
| MATERIAL | A | B | C | D | E | A |
| | Epoxy-functional Component | | | | | |
| Epoxy | 53.56 ^{b} | 81.17 ^{b} | 80.52 ^{a} | 53.47 ^{c} | 80.50 ^{a} | 103.83 ^{a} |
| Co-binder | 157.77 ^{e} | 162.32 ^{e} | 34.74 ^{f} | 112.509 ^{g} | 26.90 ^{h} | — |
| resin | | | | | | |
| Corrosion | 169.87 | 187.12 | 209.70 | 209.70 | 209.70 | 146.21 |
| inhibitor ^{j} | | | | | | |
| Micaceous | 381.90 | 362.30 | 337.00 | 381.20 | 337.00 | 414.56 |
| Iron Oxide | | | | | | |
| Glass flake | 34.71 | 0 | 35.80 | 34.64 | 35.80 | 0 |
| Rheology | 19.86 | 17.15 | 18.50 | 19.863 | 18.50 | 15.75 |
| modifiers | | | | | | |
| Solvent | 99.32 | 190.18 | 202.90 | 140.00 | 202.90 | 183.19 |
| TOTALS | | | | | | |
| | Siloxane-functional Component | | | | | |
| Polysiloxane ^{d} | 48.92 | 48.92 | 73.50 | 48.83 | 73.50 | 136.48 |
| organosilane ⁱ | 8.63 | 8.63 | 13.00 | 8.60 | 13.00 | — |
| Solvent | 31.52 | 31.52 | 2.30 | 31.45 | 2.30 | — |
| TOTALS | | | | | | |
| MIXED | 1000 | 1000 | 1000 | 1000 | 1000 | 1000 |
| TOTALS | | | | | | |

^{a} Epoxy A - Dow Chemical DEN ™ 438, epoxy novolac resin;
^{b} Epoxy B - Dow Chemical DEN ™ 439, epoxy novolac resin;
^{c} Epoxy C - HYPOX ® RF 1320, bisphenol F epoxy resin;
^{d} Dow Corning HTC 926 aminofunctional silicone resin (phenyl R₂SiO 50-70% and Me₂SiO 20-30%);
^{e} DOW PMPS 8;
^{f} Evonik Silikoftal ® HTT, polyester silicone;
^{g} phenyl methylpolysiloxane resin with 1:1 phenyl to methyl ratio and 50-65 wt % silicon dioxide content;
^{h} DOW Corning HTC 422 low molecular weight (1500-5000) silanol functional phenyl-methyl silicone resin with phenyl to methyl ratio of 1:1 to 2:1;
ⁱ aminopropyltriethoxysilane;
^{j} mixture of HALOX 750 and NUBRINOX 301.

TABLE II

| | | | | Corrosion | Corrosion |
|---|---|---|---|---|---|
| | Siloxane | Epoxy | Co-binder | Inhibitor | Inhibitor |
| Formu- | resin | resin | resin | I | II |
| lation | wt. % | wt. % | wt. % | wt. % | wt. % |
| 1^{∥} | HTC 926 | Den 438 | HTC 422 | Halox SZP | Busan |
| | 5-10 | 5-10 | 1-10 | 391 | 11-M |
| | | | | 5-10 | 5-10 |
| 2 | HTC 926 | Den 438 | HTC 422 | Halox SZP | Halox 750 |
| | 5-10 | 5-10 | 1-10 | 391 | 3-6 |
| | | | | 5-10 | |
| 3 | HTC 926 | Den 438 | HTC 422 | Halox SZP | Nubirox |
| | 5-10 | 5-10 | 1-10 | 391 | 301 |
| | | | | 5-10 | 3-6 |
| 4 | HTC 926 | Den 439 | DC 806 | Halox 750 | Nubirox |
| | 5-10 | 5-10 | 1-10 | 4-8 | 301 |
| | | | | | 3-6 |
| 5 | HTC 926 | Den 439 | DC 806 | Halox 750 | Barium |
| | 5-10 | 5-10 | 1-10 | 4-8 | sulfate |
| | | | | | 5-10 |
| 6 | DC 3055 | Den 439 | DC 806 | Halox 750 | Nalzin |
| | 5-10 | 5-10 | 1-10 | 4-8 | 3-6 |
| 7 | DC 3055 | Den 440 | DC 233 | Halox 700 | SAPP |
| | 5-10 | 5-10 | 1-10 | 5-10 | 3-6 |
| 8 | DC 3055 | Den 440 | DC 233 | Halox 700 | CMP |
| | 5-10 | 5-10 | 1-10 | 5-10 | 3-6 |
| 9 | DC 3055 | Den 440 | DC 233 | Halox 700 | ZCP |
| | 5-10 | 5-10 | 1-10 | 5-10 | 3-6 |
| 10 | DC 3055 | HyPox | DC 805 | Nubirox | Halox 550 |
| | 5-10 | 1320 | 1-10 | 301, | 4-8 |
| | | 5-15 | | 4-8 | |
| 11 | DC3055 | HP1250 | DC 805 | Nubirox | Moly White |
| | 5-10 | 5-15 | 1-10 | 106 | 4-8 |
| | | | | 5-10 | |
| 12 | HP 2000 | HP 1250 | HTT | Halox SZP | Nacorr |
| | 3-15 | 5-15 | 1-10 | 391 | 1151 |
| | | | | 5-10 | 5-10 |
| 13 | HTC 926 | Den 438 | HTT | Halox 750 | Barium |
| | 5-15 | 5-10 | 1-10 | 5-10 | sulfate |
| | | | | | 5-10 |
| 14 | HP 2000 | HP 1250 | HTC 937 | Halox SZP | Nacorr |
| | 3-15 | 5-15 | 1-10 | 391 | XR-424 |
| | | | | 5-10 | 5-10 |
| 15 | DC 3055 | DEN 438 | HTC 937 | Halox 750 | ZnO |
| | 5-10 | 5-10 | 1-10 | 5-10 | 3-6 |
| 16 | HTC 926 | Hypox | HTC 937 | Halox | ZnO/BS |
| | 5-10 | 1320 | 1-10 | 750 | 3-6 |
| | | 5-10 | | 5-10 | |
| 17 ^{†} | HTC 926 | Den 438 | HTC 422 | Halox SZP | Busan |
| | 5-10 | 5-10 | 1-10 | 391 | 11-M |
| | | | | 5-20 | 5-10 |
| 18 ^{‡} | HTC 926 | DEN 438 | HTC 422 | Halox SZP | Busan |
| | 5-10 | 5-10 | 1-10 | 391 | 11-M |
| | | | | 5-20 | 5-10 |
| C1 | HTC 926 | DEN 438 | — | Halox SZP | — |
| | 5-10 | 5-10 | | 391 | |
| | | | | 5-20 | |
| C2 | HTC 926 | DEN 438 | — | Halox SZP | Busan |
| | 5-10 | 5-10 | | 391 | 11-M |
| | | | | 5-10 | 5-10 |

^{∥}Formulations 1-16, C1 and C2 include micaceous iron oxide and glass flake as barrier pigments;
^{†} Formulation 17 includes micaceous iron oxide, aluminum, and glass flake as barrier pigments;
^{‡} Formulation 18 includes aluminum and glass flake as the barrier pigments;
HTC 926 - Dow Corning ® ammo-functional silicone resin amino-functional silicone resin (phenyl R₂SiO 50-70% and Me₂SiO 20-30%); DC 3055 - Dow Corning ® amino-functional siloxane resin; HP 2000 - Silres ® amine-functional siloxane; DEN ™ 438 - Dow Chemical epoxy novolac resin; DEN ™ 439 - Dow Chemical epoxy novolac resin; DEN ™ 440 - Dow/Olin epoxy novolac resin; HYPOX ® 1320, bisphenol F epoxy resin; HP 1250 - SILRES ® HP 1250, glycidyloxy functional silicone polymer; HTC 422 - DOW Corning ® HTC 422 low molecular weight (1500-5000) silanol functional phenyl-methyl silicone resin with phenyl to methyl ratio of 1:1 to 2:1; DC 806 - Dow Corning ® silanol-functional resin; DC 233 - Dow Corning ® hydroxyl-functional silicone resin; DC 805 - Dow Corning ® silanol-functional resin; HTT - Evonik Silikoftal ® HTT, polyester silicone; HTC 937 - Dow Corning ® PDMS.

TABLE III

| | Siloxane | Epoxy | Co-binder | Corrosion | Corrosion | Barrier | Barrier |
|---|---|---|---|---|---|---|---|
| | resin | resin | resin | Inhibitor I | Inhibitor II | pigment I | pigment II |
| Formulation | weight (g) | weight (g) | weight (g) | weight (g) | weight (g) | weight (g) | weight (g) |
| 1 | HTC 926 | Den 438 | HTC 422 | Halox SZP 391 | Busan 11-M | MIO | Glass flake |
| | 7.5 | 7.0 | 3.0 | 5.0 | 6.0 | 18.0 | 9.0 |
| 4 | HTC 926 | Den 439 | DC 806 | Halox 750 | Nubirox 301 | MIO | Glass flake |
| | 7.5 | 6.5 | 3.0 | 5.0 | 5.0 | 18.0 | 9.0 |
| 13 | HTC 926 | Den 438 | HTT | Halox 750 | Barium sulfate | MIO | Glass flake |
| | 7.5 | 7.0 | 3.0 | 5.0 | 6.0 | 18.0 | 9.0 |
| 16 | HTC 926 | Hypox 1320 | HTC 937 | Halox 750 | ZnO/BS | MIO | Glass flake |
| | 7.5 | 6.0 | 3.0 | 5.0 | 6.0 | 18.0 | 9.0 |
| 17 | HTC 926 | Den 438 | HTC 422 | Halox SZP 391 | Busan 11-M | MIO 7.0 | Glass flake |
| | 7.5 | 7.0 | 3.0 | 5.0 | 6.0 | Aluminum 6.5 | 9.0 |
| 18 | HTC 926 | DEN 438 | HTC 422 | Halox SZP 391 | Busan 11-M | Aluminum | Glass flake |
| | 7.5 | 7.0 | 6.0 | 5.0 | 6.0 | 11.0 | 9.0 |
| C1 | HTC 926 | DEN 438 | — | Halox SZP 391 | — | MIO | Glass flake |
| | 7.5 | 5.0 | | 5.0 | | 18.0 | 9.0 |
| C2 | HTC 926 | DEN 438 | — | Halox SZP 391 | Busan 11-M | MIO | Glass flake |
| | 7.5 | 5.0 | | 5.0 | 6.0 | 18.0 | 9.0 |

See Table II for description of ingredients; total for each formulation is 100 g weight, wherein the remainder for each sample (to 100 g) includes the reactive organosilane, filler, rheology modifier, and solvent.

Tests Performed

The epoxy-functional component and siloxane-functional component were combined in a single vessel and stirred for 2 minutes. Coatings of 250-300 micrometers were applied on blasted carbon steel panels having a profile of 25-50 micrometers. Thermographic analysis for mass loss (loss on ignition, LOI) according to ASTM E-2402 (see Table IV) and salt fog exposure according to ASTM B-117, ISO 7253 (Table V) were performed. As observed in Table IV, formulations B and D, each comprising a thermoset PMPS co-binder resin, were tested for LOI. These inventive formulations showed less LOI when compared to the “comparative A” formulation comprising no thermoset co-binder resin. For formulation B, this difference is observed at all temperatures below 315° C., while for formulation D the difference is observed at all temperatures below 260° C. Less LOI indicates that fewer cracks and/or pores may form in the coating after thermal cycling.

Corrosion performance for the inventive and comparative coatings, measured after salt fog exposure according to ASTM B-117, is shown in Table V. The amount of field rust was evaluated according to ASTM D610, where a rating of 10 indicates no rust, 9 indicates <0.3% rust, 8 indicates <0.1% rust, 7 indicates <0.3% rust, and 6 indicates <1.0% rust. The amount of scribe creepage was evaluated according to ASTM D1654 (an X is scribed onto the coating prior to salt fog exposure, and the amount of rust creep beyond the X is evaluated), where a rating of 10 indicates no creepage, 9 indicates 1/64 creepage, 8 indicates 1/32 creepage, 7 indicates 1/16 creepage, and 6 indicates ⅛ creepage, as fractions of a millimeter. This data is reported in Table V as (field rust)/(scribe creepage), each on the scale of 1-10 as listed above, at ambient (AM) and 400° F. (204° C.) temperatures.

TABLE IV

| | Comparative A | Formulation B | Formulation D |
|---|---|---|---|
| Exposure | % mass loss | | |
| 150 C./300 F. | 3.2 | N/A | N/A |
| 204 C./400 F. | 4.9 | 1.0 | 3.2 |
| 260 C./500 F. | 7.6 | 2.5 | 5.9 |
| 315 C./600 F. | 9.7 | 5.4 | 13.6 |
| 430 C./800 F. | N/A | 11.1 | 18.5 |

Average of 5 samples taken with 24 hour exposure at each temperature listed

TABLE V

| Hours | Comparative A | | Formulation B | | Formulation C | | Formulation D | | Formulation E | |
|---|---|---|---|---|---|---|---|---|---|---|
| of | Temperature | | | | | | | | | |
| Exposure | AM | 400 F. | AM | 400 F. | AM | 400 F. | AM | 400 F. | AM | 400 F. |
| 500 hours | 10/10 | 9/8 | 10/10 | 10/10 | 10/10 | 10/10 | 10/10 | 10/10 | N/A | N/A |
| 1000 hours | 9/9 | 7/8 | 9/8 | 9/8 | 10/10 | 10/10 | 10/10 | 10/10 | 10/10 | 10/10 |
| 1500 hours | 6/9 | 7/8 | 9/8 | 9/6 | 10/10 | 10/9 | 10/10 | 10/10 | 10/10 | 10/10 |
| 2000 hours | n/a | n/a | 9/7 | 9/6 | 10/10 | 9/9 | 10/9 | 10/9 | 10/10 | 10/10 |

Blasted carbon steel panels with a profile 25-50 um, average dry film thickness 10-12 mils (250-300 um). AM is ambient temperature exposure, test results listed as (field rust)/(scribe creepage), each on a scale of 1-10 as listed in the description.

The data in Table V demonstrate that inclusion of the thermoset co-binder resin provides improved resistance to corrosion, measured as a decrease in both the field rust (first number) and scribe creepage (second number). Additional testing was performed on the formulations presented in Table III, results of which are shown in Table VI.

Heat resistance of the coatings was measured according to ASTM 2485, which specifically tests for adhesion after cycles of heat exposure followed by an ice water quench. Listed in Table VI are the wet/dry failure temperatures, wherein a coating is considered to pass the test if it remains adherent after 15 cycles heat/ice water quench: 700 F/wet & 900 F/dry. Adherence may be measured using electrical impedance spectroscopy (EIS, where values of >10⁶ ohms*cm² indicate good barrier performance, corrosion protection) to evaluate permeability before and after thermal exposure, by LOI, or by observation of the amount of debonding.

Hardness of the coatings was measured according to ASTM D3363, which tests the gouge and scratch hardness of a coating using different grades of pencil lead to cut through the coating surface. Listed in Table VI are the pencil hardness at 24 and 72 hours, where a coating is considered to pass the test if it does not gouge or scratch until a pencil hardness of H at 24 hours and 3H at 72 hours.

Adhesion of the coatings was measured according to ASTM D4541, which evaluates the pull-off strength of a coating from a metal substrate. Listed in Table VI are the pressures at which the coating starts to pull-off from the substrate, where a coating is considered to pass the test if it remains adherent on the substrate up to at least 600 psi pull strength.

Impact resistance for the coatings was measured according to ADTM D2794, which tests for deformation of the coating film after impact from a ball or punch at room temperature. Listed in Table VI are the impact pressures at which deformation was first noted, where a coating is considered to pass the test if no deformation occurs after an impact of at least 100 lbs.

Corrosion resistance for the coatings was measured after salt fog exposure according to ASTM B-117, where both the field rust, measured according to ASTM D610, and the scribe creepage, measured according to ASTM D1654 were evaluated (each as defined above). Listed in Table VI are the number of hours of salt fog exposure before which the coating showed a 10/9 rating, wherein the 10/9 rating indicates no field rust (first number of 10) and only 1/64 creepage, as fractions of a millimeter (second number of 9). A coating is considered to pass the test if it shows a 10/9 rating after 2000 hours exposure of salt fog exposure.

Also shown in Table VI are results from testing in a CUI chamber, where coatings were exposed to cycles of wet and dry exposure to heat followed by quenching in cold water. Results from the testing are reported as corrosion resistance measured according to ASTM D610 (field rust) and ASTM D1654 (scribe creepage) as described above. Listed in Table VI is the number of hours of CUI chamber exposure before which the coating showed a 10/9 rating, wherein the 10/9 rating indicates no field rust (first number of 10) and only 1/64 creepage, as fractions of a millimeter (second number of 9). A coating is considered to pass the test if it shows a 10/9 rating after 1008 hours exposure in the CUI chamber.

TABLE VI

| | | Hardness | | | | | CUI | | |
|---|---|---|---|---|---|---|---|---|---|
| | Cyclic Flexibility | 24/72 hr | Adhesion | | Impact | | Chamber/400 F. | | Salt Fog |
| Formulation | ASTM 2485 | ASTM D3363 | ASTM D4541 | | ASTM D2794 | | Wet/Dry Cyclic | | ASTM B-117 |
| C1 | 400 F. & 500 F. | 6B/H | 400 | psi | 80 | Lbs. | 504 | hrs | 1500 hrs. |
| C2 | 500 F. & 600 F. | 5B/3B | 300-400 | psi | 100 | Lbs. | 10008 | hrs. | 1500 hrs. |
| 1 | 700 F. & 900 F. | H/5H | 600-900 | psi | >120 | Lbs. | 1008 | hrs. | 2000 hrs. |
| 4 | 700 F. & 900 F. | 3B/3H | 500-700 | psi | >120 | Lbs. | 10008 | hrs. | 1500 hrs. |
| 13 | 700 F. & 900 F. | 4B/7H | 600-900 | psi | 80-90 | Lbs. | 762 | hrs. | 2500 hrs. |
| 16 | 700 F. & 900 F. | 2B/3H | 400 | psi | 110-120 | Lbs. | 10008 | hrs. | 2000 hrs. |

The data in Table VI demonstrate that inclusion of the thermoset co-binder resin improves the thermal performance of the inventive coating, observed as in increase in the cyclic flexibility, hardness after 72 hours, adhesion, impact resistance, and corrosion resistance after salt fog exposure and CUI chamber testing.

The inventive coating formulations (1, 4, and 13) demonstrate improved adhesion, and inventive coating formulations (1, 13, and 16) demonstrate improved corrosion resistance as compared to comparative coatings C1 and C2.

Whereas particular embodiments of the present invention have been described above for purposes of illustration, it will be appreciated by those skilled in the art that numerous variations of the details of the various embodiments may be made without departing from the broad inventive concept thereof. It is understood, therefore, that this invention is not limited to the particular embodiments disclosed, but is intended to cover modifications which are within the spirit and scope of the present invention.

What is claimed is:

1. A dual-cure epoxy-siloxane coating composition comprising:
(A) an epoxy-functional component comprising:
(i) an epoxy resin, and
(iii) a corrosion inhibitor;
(B) a siloxane-functional component comprising:
(i) a polysiloxane resin, and
(ii) a reactive organosilane; and
wherein either or both of the epoxy-functional component and the siloxane-functional component further comprise:
(iii) a thermoset co-binder resin comprising an inorganic polymer backbone.

2. The coating composition of claim 1, wherein the epoxy resin comprises a cycloaliphatic epoxy, a novolac epoxy, or a combination thereof.

3. The coating composition of claim 1, wherein the epoxy resin comprises more than one epoxide group per molecule with an epoxide equivalent weight of 100 to 300.

4. The coating composition of claim 1, wherein the thermoset co-binder resin comprises a resin that cures at temperatures of at least 100° C.

5. The coating composition of claim 1, wherein the thermoset co-binder resin comprises a polysiloxane resin, a polyester-siloxane resin, or a combination thereof.

6. The coating composition of claim 1, wherein the co-binder resin comprises a phenylmethylpolysiloxane having a phenyl to methyl ratio of 1:1 to 2:1.

7. The coating composition of claim 1, wherein the corrosion inhibitor comprises a zinc or phosphate based corrosion inhibitor, or an organic corrosion inhibitor.

8. The coating composition of claim 1, wherein the polysiloxane resin comprises an amino-functional siloxane, a silanol-functional siloxane, or a combination thereof.

9. The coating composition of claim 1, wherein the reactive organosilane comprises a trialkoxy-functional silane having the formula:
X—R—Si(OR′)₃, wherein
X is a nonhydrolyzable organic radical comprising an amino, vinyl, aryl, alkyl, dialkylaryl, alkoxyalkyl, alkylaminoalkyl, or cycloalkyl radical, R is an aryl, alkyl, hydroxyalkyl, alkoxyalkyl, or hydroxyalkoxyalkyl group having less than six carbon atoms, and each R′ is independently an alkyl, hydroxyalkyl, alkoxyalkyl, or hydroxyalkoxyalkyl group each containing less than six carbon atoms.

10. The coating composition of claim 9, wherein the trialkoxy-functional silane has a general formula: 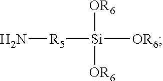
wherein
(a) R₅ is a difunctional organic radical comprises an aryl, an alkyl, a dialkylaryl, an alkoxyalkyl, an alkylaminoalkyl, or a cycloalkyl radical; and
(b) each R₆ is independently an alkyl, a hydroxyalkyl, an alkoxyalkyl, or a hydroxyalkoxyalkyl group containing less than six carbon atoms.

11. The coating composition of claim 1, wherein the epoxy-functional component and/or the siloxane-functional component further comprise a solvent.

12. The coating composition of claim 1, further comprising a barrier pigment comprising micaceous iron oxide, glass flake, aluminum, or any combination thereof.

13. A substrate at least partially coated with a coating deposited from the coating composition of claim 1.

14. The substrate of claim 13, wherein the substrate comprises a metal substrate.

15. A dual-cure epoxy-siloxane coating composition comprising:
an epoxy-functional component comprising:
3 to 30 weight percent of an epoxy resin,
5 to 30 weight percent of a corrosion inhibitor, and
5 to 30 weight percent of a solvent;
a siloxane-functional component comprising:
3 to 30 weight percent of a polysiloxane resin, and
0.5 to 5 weight percent of a reactive organosilane; and
wherein either or both of the epoxy-functional component and the siloxane-functional component further comprise:
1 to 40 weight percent of a thermoset co-binder resin comprising an inorganic polymer backbone,
wherein the weight percent is based on the total weight of the coating composition.

16. The coating composition of claim 15, further comprising:
20 to 60 weight percent of a barrier pigment, based on the total weight of the coating composition.

17. The coating composition of claim 15, wherein the co-binder resin comprises a phenylmethylpolysiloxane having a phenyl to methyl ratio of 1:1 to 2:1, and the reactive organosilane comprises a trialkoxy-functional silane with the general formula: 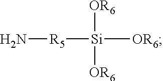
(a) R₅ is a difunctional organic radical comprising an aryl, an alkyl, a dialkylaryl, an alkoxyalkyl, an alkylaminoalkyl, or a cycloalkyl radical; and
(b) each R₆ is independently an alkyl, a hydroxyalkyl, an alkoxyalkyl, or a hydroxyalkoxyalkyl group containing less than six carbon atoms.

18. A method for coating a substrate with the coating composition of claim 1, the method comprising:
applying the coating composition to at least a portion of a surface of the substrate; and
curing the coating, wherein a first cure occurs under ambient conditions, and a second cure occurs when the substrate is heated to temperatures above 100° C.

19. The coating composition of claim 1, wherein after application and cure, the cured coating shows less than 0.03% field rust as measured by ASTM D610 after 2000 hours salt fog exposure at ambient temperatures according to ASTM B 117.

20. The coating composition of claim 1, wherein after application and cure, the cured coating has a loss on ignition (LOI) according to ASTM E2402 of less than 10% after 24 hours exposure at 260° C.
